(19) United States
(12) Patent Application Publication
(10) Pub. No.: US 2022/0285683 A1
(43) Pub. Date: Sep. 8, 2022

(54) NEGATIVE ELECTRODE ACTIVE MATERIAL, NEGATIVE ELECTRODE LAYER, AND FLUORIDE ION SECONDARY BATTERY

(71) Applicant: HONDA MOTOR CO., LTD., Tokyo (JP)

(72) Inventors: Akihisa TANAKA, Saitama (JP); Yoshiyuki MORITA, Saitama (JP)

(21) Appl. No.: 17/577,017

(22) Filed: Jan. 17, 2022

(30) Foreign Application Priority Data
Mar. 3, 2021 (JP) 2021-033737

(51) Int. Cl. H01M 4/58; H01M 10/0525

(52) U.S. Cl. CPC H01M 4/582; H01M 10/0525; H01M 2004/027

(57) ABSTRACT

Provided is a negative electrode active material including AlF₃, Li₃AlF₆, and Li₂ZrF₆. Furthermore, a negative electrode layer including the negative electrode active material is provided. Additionally, a fluoride ion secondary battery, including the negative electrode layer, an electrolyte, and a positive electrode layer is provided.

This application is based on and claims the benefit of priority from Japanese Patent Application No. 2021-033737, filed on 3 Mar. 2021, the content of which is incorporated herein by reference.

### BACKGROUND OF THE INVENTION

### Field of the Invention

The present invention relates to a negative electrode active material, a negative electrode layer, and a fluoride ion secondary battery.

### Related Art

Conventionally, a lithium ion secondary battery is widely prevalent as a secondary battery having a high energy density. The lithium ion secondary battery includes a separator disposed between a positive electrode and a negative electrode and is filled with an electrolytic solution.

The electrolytic solution for the lithium ion secondary battery may have a safety problem against heat because the electrolytic solution usually includes a flammable organic solvent.

Therefore, a fluoride ion secondary battery has been considered as an all-solid battery in which a solid electrolyte layer is disposed between a positive electrode layer and a negative electrode layer (see, for example, Patent Documents 1 to 6).

Patent Document 1: Japanese Unexamined Patent Application, Publication No. 2019-87403

Patent Document 2: Japanese Unexamined Patent Application, Publication No. 2017-50113

Patent Document 3: Japanese Unexamined Patent Application, Publication No. 2019-29206

Patent Document 4: Japanese Unexamined Patent Application, Publication No. 2018-206755

Patent Document 5: Japanese Unexamined Patent Application, Publication No. 2018-198130

Patent Document 6: Japanese Unexamined Patent Application, Publication No. 2018-92863

### SUMMARY OF THE INVENTION

As a negative electrode active material for fluoride ion secondary batteries, aluminum fluoride has been studied, but aluminum fluoride has an insulating property, so that an electrochemical reaction hardly occurs.

Therefore, although it is proposed to use Li₃AlF₆ as a negative electrode active material for fluoride ion secondary batteries, it is desired to further improve charge and discharge capacity of a fluoride ion secondary battery.

An object of the present invention is to provide a negative electrode active material that can improve the charge and discharge capacity of a fluoride ion secondary battery.

One aspect of the present invention relates to a negative electrode active material including AlF₃, Li₃AlF₆, and Li₂ZrF₆.

The negative electrode active material may include a composite of AlF₃, Li₃AlF₆, and Li₂ZrF₆.

Another aspect of the present invention relates to a negative electrode layer, including the negative electrode active material described above.

Another aspect of the present invention relates to a fluoride ion secondary battery, including the negative electrode layer, an electrolyte, and a positive electrode layer.

According to the present invention, a negative electrode active material which can improve charge and discharge capacity of a fluoride ion secondary battery can be provided.

### BRIEF DESCRIPTION OF THE DRAWINGS

FIG. 1 is an XRD spectrum of an AlF₃—Li₃AlF₆—Li₂ZrF₆ composite of Example 1;

FIG. 2 shows SEM-photographs and EPMA analysis results of the AlF₃—Li₃AlF₆—Li₂ZrF₆ composite of Example 1; and

FIG. 3 is a diagram showing the first charge and discharge curves of all-solid fluoride ion secondary batteries of Examples 1 and 2 and Comparative Examples 1 and 2.

### DETAILED DESCRIPTION OF THE INVENTION

Below, the embodiments of the present invention will be described.

### <Negative Electrode Active Material>

The negative electrode active material of the present embodiment includes AlF₃, Li₃AlF₆, and Li₂ZrF₆. Thus, the charge and discharge capacity when the negative electrode active material of the present embodiment is applied to a fluoride ion secondary battery is improved.

Here, Li₂ZrF₆ is defluorinated prior to AlF₃ and Li₃AlF₆ during charging, this stabilizes the voltage of the fluoride ion secondary battery, whereby defluorination of AlF₃ and Li₃AlF₆ becomes easier, which improves the charge/discharging capacity of the fluoride ion secondary battery.

The molar ratio of Li₃AlF₆ to AlF₃ is preferably 0.1 or more, and more preferably 0.5 or more. When the molar ratio of Li₃AlF₆ to AlF₃ is 0.1 or more, defluorination of AlF₃ easily occurs, because the inactive AlF₃ is more likely to be brought into contact with Li₃AlF₆.

The molar ratio of Li₂ZrF₆ to AlF₃ is preferably 0.1 or more and 3 or less, and more preferably 0.3 or more and 1.5 or less. When the molar ratio of Li₂ZrF₆ to AlF₃ is 0.1 or more, defluorination of AlF₃ easily occurs, because Li₂ZrF₆ is more likely to be brought into contact with inactive AlF₃ and voltage stability of the fluoride ion secondary battery is improved. Furthermore, when the molar ratio of Li₂ZrF₆ to AlF₃ is 3 or less, the capacity and voltage of the fluoride ion secondary battery are improved.

The negative electrode active material of the present embodiment may further include a negative electrode active material other than AlF₃, Li₃AlF₆, and Li₂ZrF₆.

The negative electrode active material other than AlF₃, Li₃AlF₆, and Li₂ZrF₆ is not particularly limited as long as it is a negative electrode active material used in fluoride ion secondary batteries.

[Composite of AlF₃, Li₃AlF₆, and Li₂ZrF₆]

The negative electrode active material of the present embodiment may include a composite of AlF₃, Li₃AlF₆, and Li₂ZrF₆. Thereby, the charge and discharge capacity when the negative electrode active material of the present embodiment is applied to a fluoride ion secondary battery is improved.

The composite of AlF₃, Li₃AlF₆, and Li₂ZrF₆ is, for example, at least partially covered with Li₂ZrF₆ on the surfaces of AlF₃ and Li₃AlF₆.

A particle size of the composite of AlF₃, Li₃AlF₆, and Li₂ZrF₆ is preferably 1 mm or less, and more preferably 200 μm or less. When the particle size of the composite of AlF₃, Li₃AlF₃, and Li₂ZrF₆ is 1 mm or less, particles easily form uniform powder when producing a powder composition for the negative electrode layer.

[Method for Producing Composite of AlF₃, Li₃AlF₆, and Li₂ZrF₆.]

The composite of AlF₃, Li₃AlF₆, and Li₂ZrF₆ is obtained by grinding AlF₃, LiF, and ZrF₄, followed by calcination. At this time, after LiF and ZrF₄ react with each other at a molar ratio of 2:1 to produce Li₂ZrF₆, the remaining LiF and AlF₃ react with each other at a molar ratio of 3:1 to form Li₃AlF₆, and AlF₃ remains.

The molar ratio of LiF to AlF₃ is preferably 1 or more and 5 or less. When the ratio of LiF to AlF₃ is 1 or more and 5 or less, AlF₃ is more easily defluorinated, because the composite of AlF₃, Li₃AlF₆, and Li₁ZrF₆ has high ion conductivity.

The molar ratio of ZrF₄ to AlF₃ is preferably 0.1 or more and 3 or less, and more preferably 0.3 or more and 1.5 or less. When the molar ratio of ZrF₄ to AlF₃ is 0.1 or more, defluorination of AlF₃ more easily occurs, because the composite of AlF₃, Li₃AlF₆, and Li₂ZrF₆ has high ion conductivity. Furthermore, when the molar ratio of ZrF₄ to AlF₃ is 3 or less, capacity and voltage of the fluoride ion secondary battery are improved.

As a method for grinding AlF₃, LiF, and ZrF₄, a method of grinding by using, for example, a ball mill, and the like can be mentioned.

Calcination temperature is preferably 850° C. or higher 900° C. or less. When the calcination temperature is 850° C. or more, the reaction proceeds sufficiently, and when it is 900° C. or lower, evaporation of raw materials can be suppressed.

Calcination time is preferably 1 hour or more and 3 hours or less. When the calcination time is 1 hour or more, the reaction proceeds sufficiently, and when it is 3 hours or less, evaporation of raw materials can be suppressed.

### <Negative Electrode Layer>

The negative electrode layer of the present embodiment includes the negative electrode active material of the present embodiment, and may further include a conductive aid, a solid electrolyte, and the like.

The total content of AlF₃, Li₃AlF₆ and Li₂ZrF₆ in the negative electrode layer of the present embodiment is preferably 50% by mass or less, and more preferably 30% by mass or less. When the total content of AlF₃, Li₃AlF₆, and Li₂ZrF₆ in the negative electrode layer of the present embodiment is 50% by mass or less, the charge and discharge capacity is improved when the negative electrode layer of the present embodiment is applied to fluoride ion secondary batteries.

### [Conductive Aid]

Examples of the conductive aid include a carbon material, etc.

The carbon material may be carbon black.

Examples of the carbon black include furnace black, ketjen black, acetylene black, etc. Two or more thereof may be used in combination.

### [Solid Electrolyte]

Examples of the solid electrolyte include lanthanoid fluorides doped with the alkaline earth metal, alkaline earth metal fluorides, etc. Of these, lanthanoid fluorides doped with the alkaline earth metal are preferred from the viewpoint of ion conductivity.

The lanthanoid fluoride is not particularly limited. Examples thereof include LaF₃, CeF₃, SmF₃, and NdF₃. Two or more thereof may be used in combination.

The alkaline earth metal fluoride to be used for doping the lanthanoid fluoride is not particularly limited, as long as it has ion conductivity. Examples thereof include CaF₂, SrF₂, and BaF₂. Two or more thereof may be used in combination.

Examples of the lanthanoid fluoride doped with an alkaline earth metal fluoride include La_{0.9}Ba_{0.1}F_{2.9}, Ce_{0.95}Ba_{0.05}F_{2.95}, Ce_{0.95}Sr_{0.05}F_{2.95}, and Ce_{0.95}Ca_{0.05}F_{2.95}. Two or more thereof may be used in combination.

When the negative electrode layer of the present embodiment contains a carbon material as a conductive aid, the lanthanoid fluoride doped with an alkaline earth metal fluoride may form a composite with the carbon material. In other words, the negative electrode layer of the present embodiment may include a composite of a lanthanoid fluoride doped with an alkaline earth metal fluoride and a carbon material (hereinafter, also referred to as a composite of a lanthanoid fluoride and a carbon material).

### [Composite of Lanthanoid Fluoride and Carbon Material]

In the composite of the lanthanoid fluoride and the carbon material, for example, at least a portion of a surface of a lanthanoid fluoride particle is coated with the carbon material.

The composite of the lanthanoid fluoride and the carbon material has preferably a particle diameter of 10 μm or less and further preferably a particle diameter of 5 μm or less. The composite of the lanthanoid fluoride and the carbon material having the particle diameter of 10 μm or less improves the ion conductivity and electron conductivity.

A mass ratio of the carbon material to the lanthanoid fluoride doped with an alkaline earth metal fluoride is preferably 3% by mass or more and 20% by mass or less from the viewpoint of a balance between the ion conductivity and the electron conductivity.

The negative electrode layer of the present embodiment preferably contains 60% by mass or more and 70% by mass or less of the composite of the lanthanoid fluoride and the carbon material. When the negative electrode layer of the present embodiment contains 60% by mass or more and 70% by mass or less of the composite of the lanthanoid fluoride and the carbon material, the discharge capacity of a fluoride ion secondary battery to which the negative electrode layer of the present embodiment is applied is improved.

### [Method for Producing Composite of Lanthanoid Fluoride and Carbon Material]

A method for producing the composite of the lanthanoid fluoride and the carbon material (hereinafter also referred to as composite) includes a first step in which a mixed powder of the lanthanoid fluoride and the alkaline earth metal fluoride is obtained, a second step in which the mixed powder of the lanthanoid fluoride and the alkaline earth metal fluoride is mixed with the carbon material to thereby obtain a composite precursor, and a third step in which the composite precursor is calcined to thereby obtain a composite.

The first step is a step of mixing the lanthanoid fluoride with the alkaline earth metal fluoride to thereby obtain the mixed powder of the lanthanoid fluoride and the alkaline earth metal fluoride. In other words, the mixing of the lanthanoid fluoride with the alkaline earth metal fluoride can shorten a solid phase diffusion distance of elements derived from the lanthanoid fluoride and the alkaline earth metal fluoride during calcining. Furthermore, after calcining, a mixed powder of the lanthanoid fluoride and the alkaline earth metal fluoride in which no crystal structure of the lanthanoid fluoride or the alkaline earth metal fluoride remains can be obtained.

A method for mixing the lanthanoid fluoride with the alkaline earth metal fluoride is not particularly limited. Either a dry method or a wet method may be used. For example, these may be mixed with a mortar.

Note that, conditions under which the lanthanoid fluoride is mixed with the alkaline earth metal fluoride, for example, a temperature, time, etc. may be appropriately set.

Furthermore, the mixed powder of the lanthanoid fluoride and the alkaline earth metal fluoride may be ground in the first step.

As a method for grinding the mixed powder of the lanthanoid fluoride and the alkaline earth metal fluoride, a method of grinding by using, for example, a ball mill may be mentioned.

The second step is a step of mixing the mixed powder of the lanthanoid fluoride and the alkaline earth metal fluoride obtained in the first step with the carbon material to thereby obtain the composite precursor.

In the method for producing the composite, the second step is performed before the third step to thereby mix the mixed powder of the lanthanoid fluoride and the alkaline earth metal fluoride with the carbon material in advance. Thus, the composite precursor in which the carbon material is disposed on the surface of the mixed powder of the lanthanoid fluoride and the alkaline earth metal fluoride is obtained.

Therefore, the composite precursor is calcined in the third step to thereby obtain a composite in which at least a portion of a surface of lanthanoid fluoride particle doped with alkaline earth metal fluoride is coated with the carbon material.

Furthermore, since the carbon material is disposed on the surface of the mixed powder of the lanthanoid fluoride and the alkaline earth metal fluoride in the second step, the mixed powder of the lanthanoid fluoride and the alkaline earth metal fluoride is inhibited from grain-growing or coarsening due to fusion of particle boundaries in a crystallization process in the third step, resulting in a composite having a particle diameter approximately the same as that of the mixed powder of the lanthanoid fluoride and the alkaline earth metal fluoride.

A method for mixing the mixed powder of the lanthanoid fluoride and the alkaline earth metal fluoride with the carbon material in the second step is not particularly limited. Either a dry method or a wet method may be used. For example, these may be mixed with a mortar.

Note that, when the mixed powder of the lanthanoid fluoride and the alkaline earth metal fluoride is mixed with the carbon material, shearing is preferably applied.

Furthermore, conditions under which the mixed powder of the lanthanoid fluoride and the alkaline earth metal fluoride is mixed with the carbon material, for example, a temperature, time, etc. may be appropriately set.

Moreover, the composite precursor may be ground in the second step.

As a method for grinding the composite precursor, a method of grinding by using, for example, a ball mill or a mortar, may be mentioned.

The third step is a step of calcining the composite precursor obtained in the second step to thereby obtain a composite.

Since the composite precursor in which the carbon material is disposed on the surface of the mixed powder of the lanthanoid fluoride and the alkaline earth metal fluoride is obtained in the second step, the mixed powder of the lanthanoid fluoride and the alkaline earth metal fluoride is inhibited from grain-growing or coarsening due to fusion of particle boundaries in a crystallization process in the third step, resulting in a composite having a particle diameter approximately the same as that of the composite precursor.

Note that, conditions under which the composite precursor is calcined may be appropriately set.

Furthermore, the composite may be ground in the third step.

The composite may be ground with, for example, a mortar.

<Fluoride Ion Secondary Battery>

The fluoride ion secondary battery of the present embodiment includes the negative electrode layer of the present embodiment, an electrolyte, and a positive electrode layer.

### [Electrolyte]

The electrolyte may be an electrolytic solution, a solid electrolyte, or a gel electrolyte. Furthermore, the solid electrolyte or the gel electrolyte may be organic-based or inorganic-based.

Any of known solid electrolytes may be used as the solid electrolyte. For example, the solid electrolyte included in the negative electrode layer of the present embodiment may be used as the solid electrolyte.

Note that, when the solid electrolyte is used as the electrolyte, the fluoride ion secondary battery of the present embodiment is an all-solid fluoride ion secondary battery. In the all-solid fluoride ion secondary battery, for example, a positive electrode current collector, a positive electrode layer, a solid electrolyte layer, a negative electrode layer, and a negative electrode current collector are sequentially disposed.

### [Positive Electrode Layer]

The positive electrode layer includes, for example, a positive electrode active material, a solid electrolyte, and a conductive aid. In this case, a positive electrode layer from which a sufficiently high standard electrode potential relative to that of the negative electrode layer of the present embodiment is obtained is preferably used.

Examples of the positive electrode active material include Pb, Cu, Sn, Bi, and Ag.

Examples of the solid electrolyte include PbSnF₄ and Ce₁₋ₓBaₓF₃₋ₓ.

Examples of the conductive aid include a carbon material, etc.

### [Positive Electrode Current Collector and Negative Electrode Current Collector]

Examples of the positive electrode current collector include, for example, a lead sheet and an aluminum foil. Furthermore, examples of the negative electrode current collector include, for example, a gold foil, etc.

### EXAMPLES

Although Examples of the present invention will be described hereafter, the present invention is not limited to Examples.

### Example 1

An all-solid fluoride ion secondary battery was produced as follows. Note that, unless otherwise described, each of the steps mentioned below was performed within a purge-type glove box DBO-1.5B equipped with an argon gas recycle purification system (manufactured by Miwa Manufacturing Co., Ltd.).

[Preparation of AlF₃—Li₃AlF₆—Li₂ZrF₆ Composite]

4.7 g of AlF₃ powder, 4.4 g of LiF powder, 0.9 g of ZrF₄ powder, and 20 silicon nitride grinding balls each having a diameter of 10 mm (manufactured by Fritsch) were charged into a vessel dedicated to Premium Line PL-7 (manufactured by Fritsch) serving as an 80 cc silicon nitride ball mill pot, and then sealed. Here, the ratio of AlF₃, LiF and ZrF₄ is 1:3:0.5.

The sealed ball mill pot was taken out of the glove box and then subjected to a grinding treatment with a ball mill. At this time, grinding treatment conditions were as described below.

Number of revolutions: 400 rpm

Grinding treatment time: 15 minutes

Number of times of grinding treatment: 40 times

Downtime between grinding treatments: 5 minutes

Reverse rotation: ON

The ball mill pot was brought into the glove box and then the AlF₃—Li₃AlF₆—Li₂ZrF₆ mixed powder was collected out of the ball mill pot.

After the AlF₃—Li₃AlF₆—Li₂ZrF₆ mixed powder was transferred to an alumina crucible, the mixed powder was calcined using a small size electric furnace KSL-1100X (manufactured by MTI), and an AlF₃—Li₃AlF₆—Li₂ZrF₆ composite was obtained. In this case, calcination conditions were as described below.

Flow rate of argon gas: 300 cc/min

Heating rate: 184° C./h

Maximum achievable temperature: 900° C.

Holding time at maximum achievable temperature: 1 hour

Cooling rate: No control

Cooling method: Standing to cool

The AlF₃—Li₃AlF₆—Li₂ZrF₆, composite was collected out of the alumina crucible and then ground using an agate mortar and pestle for 5 to 10 minutes.

The AlF₃—Li₃AlF₆—Li₂ZrF₆ composite was analyzed using XRD.

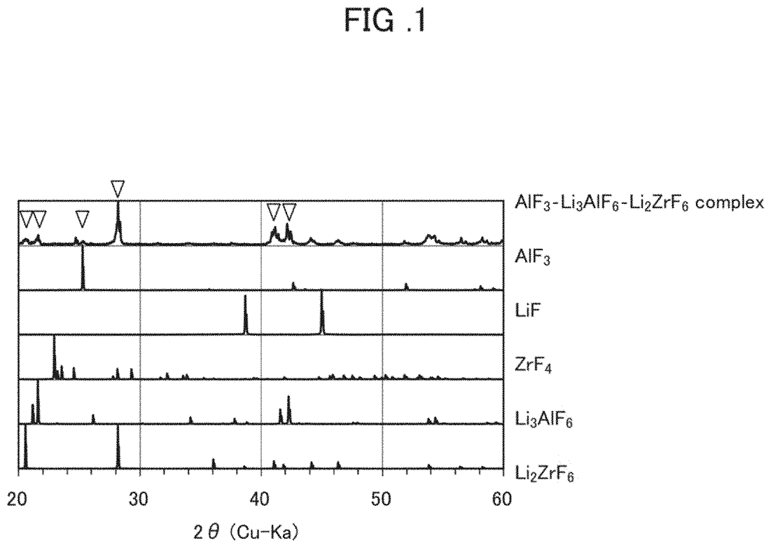

FIG. 1 is an XRD spectrum of the AlF₃—Li₃AlF₆—Li₂ZrF₆ composite. Note that FIG. 1 also shows the XRD spectra of AlF₃, LiF, ZrF₄, Li₃AlF₆, and Li₂ZrF₆.

From FIG. 1, it can be seen that in the XRD spectrum of the AlF₃—Li₃AlF₆—Li₂ZrF₆ composite, peaks derived from the raw material, LiF and ZrF₄, have disappeared and peaks derived from the product, Li₃AlF₆ and Li₂ZrF₆, have appeared.

The AlF₃—Li₃AlF₆—Li₂ZrF₆ composite was observed using SEM-EPMA. At this time, targeted elements of mapping were Al and Zr.

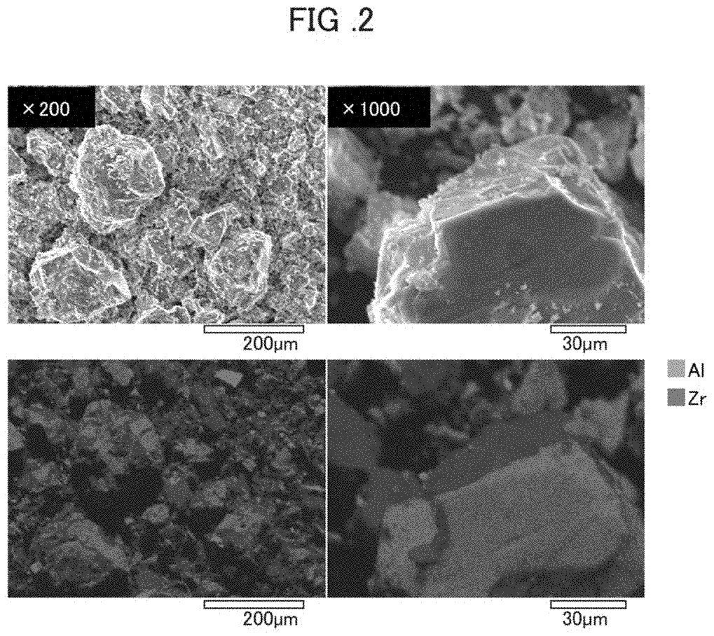

FIG. 2 shows the SEM photos and results of EPMA analyses of the AlF₃—Li₃AlF₆—Li₁ZrF₆ composite.

From FIG. 2, it can be seen that the AlF₃—Li₃AlF₆—Li₂ZrF₆ composite is covered with Li₂ZrF₆ on the surfaces of AlF₃ and Li₃AlF₆.

[Production of Ce_{0.95}Ba_{0.05}F_{2.95}-AB composite]

### (First Step)

8.598 g of CeF₃ powder (manufactured by Sigma-Aldrich; purity: 99.99%) and 0.402 g of BaF₂ powder (manufactured by Kojundo Chemical Laboratory Co., Ltd.; purity: 99.9%) were weighed and then mixed with an agate mortar and pestle for 5 to 10 minutes to thereby obtain a CeF₃—BaF₂ mixed powder.

The CeF₃—BaF₂ mixed powder and 20 silicon nitride grinding balls each having a diameter of 10 mm (manufactured by Fritsch) were charged into a vessel dedicated to Premium Line PL-7 (manufactured by Fritsch) serving as an 80 cc silicon nitride ball mill pot, and then sealed.

The sealed ball mill pot was taken out of the glove box and then subjected to a grinding treatment with a ball mill. In this case, grinding treatment conditions were as described below.

Number of revolutions: 800 rpm

Grinding treatment time: 60 minutes

Number of times of grinding treatment: 40 times

Downtime between grinding treatments: 5 minutes

Reverse rotation: ON

The ball mill pot was taken into the glove box and then the CeF₃—BaF₂ mixed powder was collected from the ball mill pot.

### (Second Step)

Using an agate mortar and pestle, 700 mg of the CeF₃—BaF₂ mixed powder was mixed with 50 mg of Denka Black (manufactured by Denka Company Limited) serving as acetylene black (AB) to thereby obtain a Ce_{0.95}Ba_{0.05}F_{2.95}-AB composite precursor.

The Ce_{0.95}Ba_{0.05}F_{2.95}-AB composite precursor, 20 zirconia grinding balls each having a diameter of 10 mm (manufactured by Fritsch), and 20 silicon nitride grinding balls each having a diameter of 10 mm (manufactured by Fritsch) were charged into a vessel dedicated to Premium Line PL-7 (manufactured by Fritsch) serving as an 80 cc silicon nitride ball mill pot, and then sealed.

The sealed ball mill pot was taken out of the glove box and then subjected to a grinding treatment with a ball mill. In this case, grinding treatment conditions were as described below.

Number of revolutions: 800 rpm

Grinding treatment time: 60 minutes

Number of times of grinding treatment: 40 times

Downtime between grinding treatments: 5 minutes

Reverse rotation: ON

The ball mill pot was taken into the glove box and then the Ce_{0.95}Ba_{0.05}F_{2.95}-AB composite precursor was collected from the ball mill pot. The collected Ce_{0.95}Ba_{0.95}F_{2.95}-AB composite precursor was ground with an agate mortar and pestle for 5 to 10 minutes.

### (Third Step)

The Ce_{0.95}Ba_{0.05}F_{2.95}-AB composite precursor was transferred into an alumina crucible and then calcined using a small size electric furnace KSL-1100X (manufactured by MTI) to thereby obtain a Ce_{0.95}Ba_{0.05}F_{2.95}-AB composite. In this case, calcination conditions were as described below.

Flow rate of argon gas: 300 cc/min

Heating rate: 184° C./h

Maximum achievable temperature: 1100° C.

Holding time at maximum achievable temperature: 1 hour

Cooling rate: No control

Cooling method: Standing to cool

The Ce_{0.95}Ba_{0.05}F_{2.95}-AB composite was collected from the alumina crucible and then ground with an agate mortar and pestle for 5 to 10 minutes.

### [Production of Powder Composition for Negative Electrode Layer]

250 mg of the AlF₃—Li₃AlF₆—Li₂ZrF₆ composite, 750 mg of the Ce_{0.95}Ba_{0.05}F_{2.95}-AB composite, and 40 g of silicon nitride grinding balls each having a diameter of 2 mm (manufactured by Fritsch) were charged into a vessel dedicated to Premium Line PL-7 (manufactured by Fritsch) serving as a 45 cc silicon nitride ball mill pot, and then sealed.

The sealed ball mill pot was taken out of the glove box and then subjected to a grinding treatment with a ball mill. In this case, grinding treatment conditions were as described below.

Number of revolutions: 300 rpm

Grinding treatment time: 15 minutes

Number of times of grinding treatment: 40 times

Downtime between grinding treatments: 5 minutes

Reverse rotation: ON

The ball mill pot was taken into the glove box and then a powder composition for a negative electrode layer was collected from the ball mill pot.

### [Production of Powder for Positive Electrode Layer (PbSnF₄-AB Composite)]

After mixing 63.7% by mass of lead fluoride powder (manufactured by Kojundo Chemical Laboratory Co., Ltd.), 29.6′ by mass of tin fluoride powder (manufactured by Kojundo Chemical Laboratory Co., Ltd.), and 6.7%, by mass of Denka Black (manufactured by Denka Company Limited) as AB in a ball mill, the resultant mixture was calcined at 400° C. for 1 hour under an argon atmosphere, resulting in a PbSnF₄-AB composite.

[Preparation of powder (Ce_{0.95}Ba_{0.05}F_{2.95}) for solid electrolyte layers]

### (First Step)

After weighing 8.598 g of CeF₃ powder (manufactured by Sigma-Aldrich Co., Ltd., purity: 99.99%) and 0.402 g of BaF₂ powder (manufactured by High Purity Chemical Laboratory Co., Ltd., purity: 99.9%), the mixture was mixed using an agate mortar and pestle for 5 to 10 minutes to obtain CeF₃—BaF₂ mixed powder.

The CeF₃—BaF₂ mixed powder, 20 silicon nitride grinding balls (manufactured by Fritsch) were charged into a vessel dedicated to Premium Line PL-7 (manufactured by Fritsch) serving as an 80 cc silicon nitride ball mill pot, and then sealed.

The sealed ball mill pot was taken out of the glove box and then subjected to a grinding treatment with a ball mill. At this time, grinding treatment conditions were as described below.

Number of revolutions: 800 rpm

Grinding treatment time: 60 minutes

Number of times of grinding treatment: 40 times

Downtime between grinding treatments: 5 minutes

Reverse rotation: ON

The ball mill pot was brought into the glove box and then the CeF₃—BaF₂ mixed powder was collected out of the ball mill pot.

### (Second Step)

The CeF₃—BaF₂ mixed powder was transferred to an alumina crucible and then calcined using a small size electric furnace KSL-1100X (manufactured by MTI) to thereby obtain Ce_{0.95}Ba_{0.05}F_{2.95}. In this case, calcination conditions were as described below.

Flow rate of argon gas: 300 cc/min

Heating rate: 184° C./h

Maximum achievable temperature: 1100° C.

Holding time at maximum achievable temperature: 1 hour

Cooling rate: No control

Cooling method: Standing to cool

Ce_{0.95}Ba_{0.05}F_{2.95} was collected out of the alumina crucible and then ground using an agate mortar and pestle for 5 to 10 minutes.

[Production of all-Solid Fluoride Ion Secondary Battery]

A cylindrical pellet cell was produced through powder-compaction by pressing at a pressure of 40 MPa using a tablet molding device. Specifically, a gold foil having a thickness of 20 μm (manufactured by The Nilaco Corporation; purity: 99.99%) serving as a negative electrode current collector, 10 mg of the powder composition for a negative electrode layer, 150 mg of the powder for a solid electrolyte layer, 20 mg of the powder for a positive electrode layer, a lead sheet having a thickness of 200 μm (manufactured by The Nilaco Corporation; purity: 99.99%) serving as a positive electrode active material and a positive electrode current collector, and an aluminum foil having a thickness of 20 μm (manufactured by The Nilaco Corporation; purity: 99+%) serving as a positive electrode current collector were charged into the tablet molding device in this order, resulting in a pellet cell.

### Example 2

An all-solid fluoride ion secondary battery was produced in the same manner as in Example 1, except that when preparing the powder composition for a negative electrode layer, a mixture of 28 mg of AlF₃ powder, 110 mg of Li₃AlF₆ powder, and 112 mg of Li₂ZrF₆ powder (molar ratio: 0.5:1:0.8) was used instead of 250 mg of AlF₃—Li₃AlF₆—Li₂ZrF₆ composite, and the grinding treatment conditions were changed as follows.

Number of revolutions: 300 rpm

Grinding treatment time: 15 minutes

Number of times of grinding treatment: 40 times

Downtime between grinding treatments: 5 minutes

Reverse rotation: ON

### Comparative Example 1

An all-solid fluoride ion secondary battery was produced in the same manner as in Example 2, except that when preparing a powder composition for a negative electrode layer, Li₃AlF₆ powder was used instead of the mixture of AlF₃ powder, Li₃AlF₆ powder, and Li₂ZrF₆ powder.

### Comparative Example 2

An all-solid fluoride ion secondary battery was produced in the same manner as in Example 2, except that when preparing the powder composition for a negative electrode layer, Li₂ZrF₆ powder was used instead of the mixture of AlF₃ powder, Li₃AlF₆ powder, and Li₂ZrF₆ powder.

[Particle Diameters of AlF₃—Li₃AlF₆—Li₂ZrF₆ Composite and Ce_{0.95}Ba_{0.05}F_{1.95}-AB Composite]

Each powder was photographed using a scanning electron microscope SU-6600 (manufactured by Hitachi High-Tech Corporation) and then powders on SEM images of a plurality of visual fields were measured for length, which was determined as a particle diameter.

As a result, the AlF₃—Li₃AlF₆—Li₂ZrF₆ composite and the Ce_{0.95}Ba_{0.05}F_{2.95}-AB composite had particle diameters of 200 μm and 50 μm, respectively.

### [Charge and Discharge Test]

The all-solid fluoride ion secondary batteries were subjected to a charge and discharge test at a constant current. Specifically, the charge and discharge test at a constant current was performed using a potentio-galvanostat device SI1287/1255B (manufactured by Solartron Analytical) in vacuum at 140° C. under the following conditions: current during charging: 0.04 mA, current during discharging: 0.02 mA, lower limit of voltage: —2.44 V, upper limit of voltage: —0.1 V, and starting with charging.

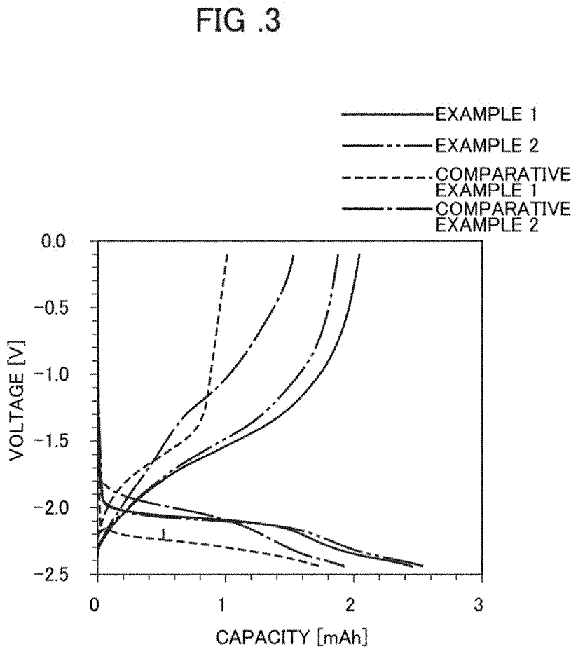

FIG. 3 shows initial charge and discharge curves of the all-solid fluoride ion secondary batteries of Examples 1 and 2 and Comparative Examples 1 and 2.

FIG. 3 demonstrates that the all-solid fluoride ion secondary batteries of Examples 1 and 2 had higher charge and discharge capacities than the all-solid fluoride ion secondary batteries of Comparative Examples 1 and 2.

What is claimed is:

1. A negative electrode active material comprising AlF₃, Li₃AlF₆, and Li₂ZrF₆.

2. The negative electrode active material according to claim 1, comprising a composite of AlF₃, Li₃AlF₆, and Li₂ZrF₆.

3. A negative electrode layer, comprising the negative electrode active material according to claim 1.

4. A fluoride ion secondary battery, comprising the negative electrode layer according to claim 3, an electrolyte, and a positive electrode layer.
